(19) United States
(12) Patent Application Publication
(10) Pub. No.: US 2002/0191607 A1
(43) Pub. Date: Dec. 19, 2002

(54) Method of transmitting an active message in a virtual circuit

(75) Inventors: Damien Galand, Chaville (FR); Olivier Marce, Massy (FR)

Correspondence Address: SUGHRUE, MION, PPLC, 2100 Pennsylvania Avenue, N.W., Washington, DC, 20037-3213, US

(73) Assignee: ALCATEL

(21) Appl. No.: 10/166,104

(22) Filed: Jun. 11, 2002

(30) Foreign Application Priority Data
Jun. 18, 2001 (FR) 01 07 958

(51) Int. Cl. H04L 12/28; H04L 12/56

(52) U.S. Cl. 370/389; 370/392

(57) ABSTRACT

A method of transmitting messages through a data network, the method comprising a first step consisting in establishing a virtual circuit between a first node and a second node, the nodes belonging to said virtual circuit forwarding the message as a function of a header, the method further comprising a step of inserting information into said header, and each node in the virtual circuit determining whether said message is an active message as a function of said information.

The present invention relates to telecommunications networks in which the nodes are capable of processing the information messages they receive in specific manner.

The invention applies particularly to active networks. This concept of an active network was introduced by the Defense Advance Research Projects Agency (DARPA) work in 1994 and has constituted the subject matter of numerous international conferences, for example the International Workshop on Active Networks conferences IWAN 99 and IWAN 2000.

### BACKGROUND OF THE INVENTION

An active network is a network in which the nodes, or some of them, are capable of processing some of the messages conveyed by the network in specific manner. In other words, this means that the nodes must be capable of running an algorithm other than those available to them at the time of design.

Within an active network, it is not necessary for all of the nodes to be provided with this processing ability: it is thus possible to distinguish between nodes that are active and nodes that are not active (i.e. normal).

In the same manner, all messages do not necessarily require specific processing: one can thus distinguish between messages (or packets) that are active and messages that are not active (i.e. normal).

This technology raises a problem when it is desired to use it together with the multi-protocol label switching (MPLS) protocol as described in request for comments (RFC) 3031 issued by the Internet engineering task force (IETF).

The MPLS protocol consists in providing the possibility of creating virtual circuits within a data network that normally operates by switching packets, such as networks using the transmission control protocol/Internet protocol (TCP/IP) stack protocols, with the Internet constituting an example thereof. In the context of an Internet network, nodes are commonly referred to as “routers” and messages as “packets”.

MPLS protocol is based on the principle of adding a header to each packet, the header containing a label or a stack of labels for defining a circuit. On receiving such a packet, a router can determine the router to which the packet should be forwarded merely by reading its labels and looking up in a correspondence table.

The correspondence table is previously negotiated by the routers that are to form part of the virtual circuit.

This method makes it possible to reserve a virtual circuit within which packets are forwarded quickly, merely on analyzing one or more labels and a correspondence table, and no longer by implementing conventional routing algorithms. The time required for a router to forward a packet is thus considerably shortened, as is the transit time for end-to-end transmission.

This method also makes it possible to be sure that all of the packets will following the same path.

However, in the context of an active network, setting up a virtual circuit raises a major technical problem. Insofar as forwarding is based solely on reading the header that has been added for this purpose, the content of the packet is not subjected to analysis. That means it cannot be determined whether or not the content forms part of a packet that is active.

### OBJECTS AND SUMMARY OF THE INVENTION

An object of the invention is to mitigate this problem by proposing a method enabling the constraints of transmission over a virtual circuit to be reconciled with the constraints of active networks.

To do this, the invention provides a method of transmitting messages through a data network, the method comprising a first step consisting in establishing a virtual circuit between a first node and a second node, the nodes belonging to said virtual circuit forwarding the message as a function of a header. This method further comprising a step of inserting information into said header, and each node in the virtual circuit determining whether said message is an active message as a function of said information.

It then becomes possible for each node forming a part of a virtual circuit, e.g. MPLS, to determine whether a received message is an active message, and if so to take the appropriate measures (for example to trigger the code contained in the message).

In a particular implementation of the invention, when a node of said virtual circuit receives an active message, it begins by duplicating the received message, forwarding one of the copies to the following node and triggering the processing associated with the active message on the other copy. This duplication mechanism can be triggered, for example, as a function of a specific identifier contained in said information.

In an implementation of the invention, said information contains data relating to the execution environment needed for processing the active message.

In a particular implementation, the virtual circuit complies with the MPLS protocol as defined in IETF's RFC 3031.

Finally, in a first implementation, the information may be inserted in the form of a label in the stack of labels of the message, or in a second implementation it may be inserted in the “Exp” field of a label of the stack of labels of the message. Naturally, other implementations are also possible.

The invention also provides a router possessing means for implementing the method.

### BRIEF DESCRIPTION OF THE DRAWINGS

The invention and its advantages appear more clearly from the following description given with reference to the accompanying figures.

FIG. 1 shows a message in a particular implementation of the invention using the MPLS protocol.

FIG. 2 shows the content of a message header in this particular implementation.

### MORE DETAILED DESCRIPTION

Typically a message (or packet) in a data network is constituted by a sequence of headers and by a message body. The sequence of headers is representative of the various layers of the network model. The headers that are closer to the message body are those corresponding to the higher layers, whereas the headers that are further from the message body (and thus closer to the beginning of the message) correspond to lower layers.

Thus, referring to the open systems interconnection (OSI) model made up of seven layers as recommended by the International Standards Organization (ISO), this means that the data link level headers are situated ahead of the network level headers.

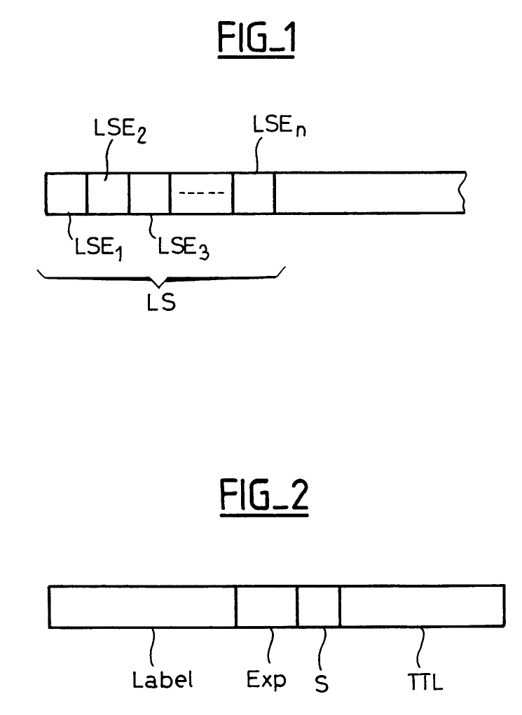

FIG. 1 shows a packet complying with the MPLS protocol. This packet contains a label stack LS situated at the beginning of the packet, i.e. before the “network” level header.

This label stack can form an independent header or it can be included in appropriate fields of a header at a level below “network” level. In other words, this label stack LS can be situated ahead of the IP header.

The label stack LS comprises a set of labels LSE₁, LSE₂, LSE₃, . . . , LSEₙ, which set can optionally be reduced to a singleton.

The structure of a label (or label stack entry LSE) is shown in FIG. 2. According to the IETF's RFC 3032, a label has four fields.

A “label” field represents the label proper, i.e. an identifier enabling the packet to be routed.

An experimental use field “Exp” is reserved for experimental purposes.

A bottom-of-stack field “S” serves to indicate whether the label in question is the last label in the stack of labels. This enables the router to detect the boundary between the label stack and the following field, e.g. an IP header.

Finally, a time-to-live field “TTL” is a conventional field encoding the age of the label. It serves to limit propagation of a packet to some defined number of hops.

In a first implementation of the invention, information is inserted in the “Exp” field of one of the labels in the label stack of the packet. This information serves, amongst other things, to indicate that the packet is question is an active packet.

In a second embodiment, which is preferred, an entire label is reserved for storing this information, for example the last label in the stack, one or more values of the “label” field can then be defined by the Internet assigned number authority (IANA) to mean that the label in question contains this kind of information.

At the least, the information must contain data making it possible to determine whether the packet is an active packet. This data can be in the form of a binary flag.

In an embodiment of the invention, this information can also contain a specific identifier, serving to inform the node (or router) receiving the packet that it must duplicate the packet prior to forwarding it to the following router. Thereafter it can trigger the processing associated with the packet without slowing down transmission. This method of operating serves to accelerate transit of an active packet through a network.

This behavior can be the “default” behavior of the router, however that is not always appropriate (particularly if the routing algorithm is to depend on the active code associated with the packet). It is therefore preferable for each packet to indicate whether or not the mechanism is to be implemented.

In an implementation of the invention, this information can also contain data relating to the execution environment needed for the processing associated with the packet. This option is particularly advantageous when the active packet contains active code (in opposition to the case where the active packet makes use of code that is not contained in the packet, but that is already in the router, or on an active code server).

There is no point in the router processing an active packet if the router is not capable of executing the associated code.

The execution environment can comprise the operating system needed to execute the code (Unix, CORBA platform, etc.) and it can also specify necessary libraries, etc.

Typically, this information is inserted by the router situated at the beginning of the virtual circuit. In MPLS terminology, such a router is referred to as an active label switch router (ALSR).

1/ A method of transmitting messages through a data network, the method comprising a first step consisting in establishing a virtual circuit between a first node and a second node, the nodes belonging to said virtual circuit forwarding the message as a function of a header, the method further comprising a step of inserting information into said header, and each node in the virtual circuit determining whether said message is an active message as a function of said information.

2/ A method according to the preceding claim, in which, when a node of said virtual circuit receives an active message, it begins by duplicating the received message, forwarding one of the copies to the following node and triggering the processing associated with the active message on the other copy.

3/ A method according to the preceding claim, in which the duplication mechanism is triggered as a function of a specific identifier contained in said information.

4/ A method according to claim 1, in which said information contains data relating to the execution environment needed for processing the active message.

5/ A method according to claim 1, in which said virtual circuit is set up in compliance with the MPLS protocol.

6/ A method according to the preceding claim, in which said information is inserted in the form of a label in the label stack of said message.

7/ A method according to claim 5, in which said information is inserted in the “Exp” field of a label in the label stack of said message.

8/ A router possessing means for implementing the method according to claim 1.
